(19) United States
(12) Patent Application Publication
(10) Pub. No.: US 2023/0059706 A1
(43) Pub. Date: Feb. 23, 2023

(54) Electric grill appliance and heating element therefor

(71) Applicant: Enders Colsman AG, Werdohl (DE)

(72) Inventor: Robin Colsman, Dortmund (DE)

(21) Appl. No.: 17/577,240

(22) Filed: Jan. 17, 2022

Related U.S. Application Data
(60) Provisional application No. 63/234,851, filed on Aug. 19, 2021.

(51) Int. Cl. F24C 7/04; F24C 7/06; F24C 7/08; F24C 15/14; H05B 3/68; A47J 37/07; A47J 36/32

(52) U.S. Cl. CPC F24C 7/046; F24C 7/067; F24C 7/083; F24C 7/087; F24C 15/14; H05B 3/68; A47J 37/0709; A47J 36/32; A47J 37/0786; H05B 2203/005

(57) ABSTRACT

An electric grill with a cooking surface for cooking food, which cooking surface has at least two adjacent heating zones is disclosed. Each heating zone of the grill is assigned a first electrical heating element 8 for heating the cooking surface in this heating zone, H₁, H₂. A second heating element 9 is arranged in a subset of the heating zones (H₁) for increasing the heating power in this heating zone (H₁) with a power input that at least matches that of a first heating element 8 of another heating zone (H₂). The grill 1 has a heating element switchover feature, such that, when a second heating element 9 is switched on in a heating zone H₁ with two heating elements 8, 9, a power corresponding to the power input of the second heating element 9 that is switched on or to be switched on is switched off on first heating elements 8 in one or more other heating zones H₁, or switching on such power is blocked.

### RELATED APPLICATION

This application is a non-provisional application which claims the benefit of U.S. provisional application 63/234,851 filed Aug. 19, 2021, which is hereby incorporated by reference for all purposes.

### BACKGROUND

The disclosure relates to an electric grill with a cooking surface for cooking food, which cooking surface has at least two adjacent heating zones. A heating element suitable for such an electric grill is also described.

In addition to grills that run on charcoal or gas, electric grills are used as well. These electric grills have a cooking surface for cooking food, like the other grills. A food to be cooked is placed on the cooking surface. The cooking surface can be designed as a grate, for example. Closed cooking surfaces with a smooth surface or surface formed by ribs are also known. As with gas grills, electric grills are already known which have two or more adjacent heating zones, i.e. zones in which the same or a different temperature can be provided on the cooking surface.

On aspect of the disclosure is an electric grill with an optimized energy input for operating a hotter heating zone. In addition, there can be the option that such a grill can be implemented having a simple and therefore inexpensive design and structure. Furthermore, there is a desire for a heating element which can be operated with greater power despite a specified installation size.

The foregoing example of the related art and limitations related therewith are intended to be illustrative and not exclusive. Other limitations of the related art will become apparent to those of skill in the art upon a reading of the specification and a study of the drawings.

### SUMMARY

The following embodiments and aspects thereof are described and illustrated in conjunction with systems, tool and methods which are meant to be exemplary and illustrative, not limiting in scope. In various embodiments, one or more of the above described problems have been reduced or eliminated, while other embodiments are directed to other improvements.

One aspect of the grill is when each heating zone is assigned a first electrical heating element for heating the cooking surface in this heating zone,
in a subset of the heating zones, a second heating element for increasing the heating power is arranged in this heating zone with a power input that corresponds at least to that of a first heating element of another heating zone, and
the grill has a heating element switchover feature, such that, when a second heating element is switched on in a heating zone with two heating elements, a power corresponding to the power input of the second heating element that is switched on or to be switched on is switched off on first heating elements in one or more other heating zones, or switching on such power is blocked.

In one embodiment of the heating element is a tubular heating element having several heating element legs connected to one another by curved arched sections, wherein, between two outer heating element legs, a heating element section is arranged with two non-parallel heating element legs and with an arched section connecting these heating element legs, wherein the distance between the heating element legs of the heating element section from one another at the transition into the arched section connecting them is greater than at the transition between these heating element legs and the two connecting arch sections for connecting the heating element section to the outer heating element legs.

In this electric grill, the cooking surface is divided into several adjacent heating zones. A first heating element is assigned to each heating zone. According to an exemplary embodiment, the sum total of the power input of these first electrical heating elements corresponds to the maximum power input of the grill. This ensures that when all heating zones are operated with their first heating element, the power input does not exceed the permitted maximum power input. At the same time, the maximum power input can be divided between these first heating elements, such that, when the grill is operated with all the first heating elements, the cooking surface can be heated with the maximum power input. In a subset of these heating zones there is at least one second heating element in addition to the first heating element. When energized, the second element increases the heating power of this heating zone. The power input of this at least second heating element typically corresponds to the maximum power input of one or more of the first heating elements in other heating zones. For example, in the case of a grill with two heating zones, the heating zone having two heating elements can be operated with the maximum permitted power. The electric grill also has a heating element switchover feature, which ensures that the first heating element is not energized in other heating zones if such a second heating element is operated in a heating zone together with the first heating element located in this heating zone. The number of non-energized first heating elements of other heating zones adds up to a non-energized power input that the second heating element has as maximum power input in such a heating zone having a first and a second heating element. As a result of this measure, the maximum power input can be concentrated on such a heating zone with a first and a second heating element, which can then be operated with an accordingly higher power. In other words: to operate such a heating zone, power that is not used for operating the same does not flow into other heating zones. For example, in the case of an electric grill having two heating zones, if the heating zone is operated with two heating energized, the first heating element of the adjacent heating zone cannot be energized as long as both heating elements are energized in the in the other heating zone.

In this electric grill, care is therefore taken that not all heating elements are energized with their maximum power input at the same time. The sum total of the power input of the total number of heating elements is thus greater than the maximum power input of the grill, which is specified either by the grill itself or by the available mains voltage. A user selects using the heating element switchover feature whether the cooking surface is to be heated over a large area or whether at least one heating zone is to be operated with at least one second additional heating element and then with an accordingly higher heating output.

In a simple embodiment of such an electric grill, the grill has two adjacent heating zones, one of which has one heating element and the other has two heating elements. The power input of the heating elements is the same in this exemplary embodiment, for example 1.5 kW. The maximum power input of the grill is 3 kW. Thus, with the maximum power input of 3 kW, either the entire cooking surface can be heated by operating the first heating elements of the two heating zones adjacent to one another in relation to the extension of the cooking surface, or by operating the two heating elements in only one heating zone. Since double the energy is available in the heating zone with the two heating elements in this exemplary embodiment, this heating zone on the cooking surface is naturally significantly warmer than when the heating zone is only heated with one heating element. In such a configuration, the heating element switchover feature can be implemented, for example, by a mechanical switching element designed as an electric changeover switch.

The design of such an electric grill can also be implemented with different power input of the first heating elements. The same applies to the design of the second heating elements. With such a design, the cooking surface has more than two heating zones. In such a design, a control circuit is typically used for the heating element switchover feature, which on the one hand receives the operating request of a user as an input variable via operating sensors—buttons or switches—and which then controls the energization of the heating zones or the integrated heating elements, depending on the operating request of the user, typically by controlling relays connected to the power supply of the individual heating elements.

Regardless of the design of the electric grill, the above statements make it clear that the maximum power input can be used for heating regardless of the operating mode, that is, over a large or smaller area. It goes without saying that the maximum power input in such an electric grill does not necessarily have to be used to operate the electric heating elements, for example if the cooking surface is to be heated at a lower temperature, but that this is possible without having to consider a power reserve for connecting a second heating element when designing the power input of a first heating element, as is the case in the prior art.

According to one embodiment, the heating elements are electrical resistance heating elements designed as heating rods (tubular heating elements), typically with a spatial extension that extends over the flat extension of the heating zone. The electrical resistance heating elements can be designed helically or spirally.

In a heating zone with a first and a second heating element, these can be provided in an arrangement one above the other. With such a design, it is expedient to provide the second heating element as the one arranged at the bottom. In an alternative embodiment, the two heating elements assigned to a heating zone are located in one and the same plane. This has the advantage that the distance between the two heating elements and the food to be heated is the same on the cooking surface.

A grate is typically used as the cooking surface. The heating elements of the heating zone are located at a distance below the grate.

The heating element according to the present disclosure can have a heating element section with two heating element legs, which are connected to one another by an arched section, is arranged between two outer heating element legs. This heating element section is in turn connected to the outer heating element legs via connecting arched sections. Such a heating element is designed helically. A special feature of the heating element is that the heating element legs of the heating element section do not run parallel to one another. Instead, they are designed such that the distance between the heating element legs in the area of the transition to the arched section connecting them is greater than on their other end in the transition to the respective connecting arched section with which this heating element section is connected to the outer heating element sections. What is achieved hereby is that the heating element has a greater length overall. This means that more power can be coupled into this heating element. In addition, the heat distribution on the cooking surface is improved, since a greater heating element length is provided in the area of the arched section connecting the heating element legs of the heating element section and thus in the central area between the outer holding legs. This area between the outer heating element legs is often located between the connecting ends of the heating element. The typically lower heating power in this area can thus be compensated for.

In a special embodiment of such an electric grill, a drip tray is located vertically below the heating elements to catch cooking liquids, such as dissolved fat, oils or the like, that fall from the grate or the food to be cooked on it. The drip tray is held inclined like a fat drawer in the frame of the grill. The inclination preferably runs towards the rear of the grill. The edge of this fat drawer facing towards the rear of the grill unit has a collecting channel in which the cooking liquids that have been caught accumulate. The collecting channel is laid out or is located in the grill at a point where it is shaded from direct IR heat radiation from the heating devices. In this way, the risk of ignition of risen oil or liquefied fat is reduced.

Typically, a heating chamber is formed by side panels suspended in the grill. These side panels can be removed without tools for cleaning purposes. These panels are inclined towards one another in the direction of the drip tray. The collecting opening of the drip plate is shaded in the vertical direction by such a side panel.

In addition to the exemplary aspects and embodiments described above, further aspects and embodiments will become apparent by reference to the accompanying drawings forming a part of this specification wherein like reference characters designate corresponding parts in the several views.

### BRIEF DESCRIPTION OF THE DRAWINGS

FIG. 1 is a schematic cross-sectional view through an electric grill with two adjacent heating zones.

FIG. 2 is a plan view of the electrical heating elements arranged in the two heating zones,

FIG. 3 is a plan view of an electric grill with two adjacent heating zones according to a further exemplary embodiment,

FIG. 4 is an enlarged detail of the arrangement and layout of the heating zones of the grill of FIG. 3.

FIG. 5 is a side view of the grill from FIG. 3.

Before explaining the disclosed embodiment of the present device in detail, it is to be understood that the invention is not limited in its application to the details of the particular arrangement shown, since the invention is capable of other embodiments. Exemplary embodiments are illustrated in referenced figures of the drawings. It is intended that the embodiments and figures disclosed herein are to be considered illustrative rather than limiting. Also, the terminology used herein is for the purpose of description and not of limitation.

### DETAILED DESCRIPTION

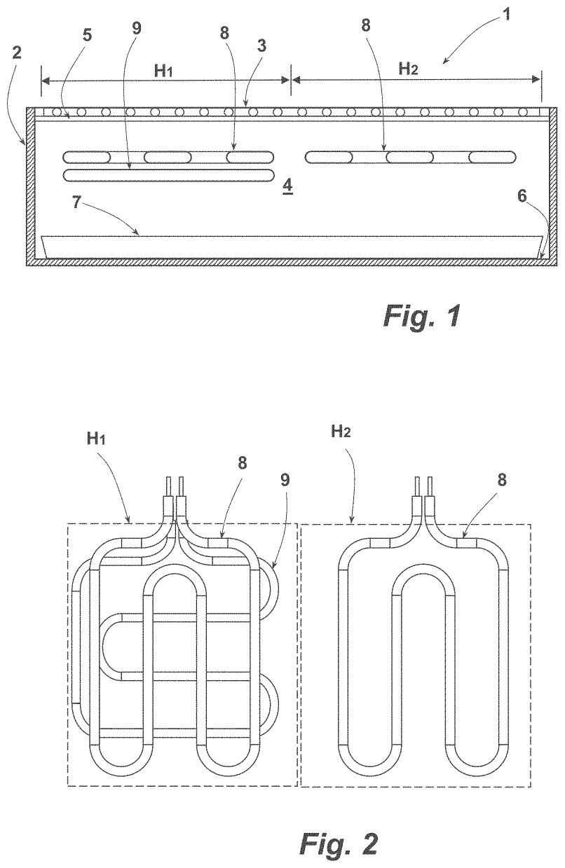

As seen in FIG. 1, an electric grill 1 comprises a housing 2, in the opening at the top of which a grill grate 3 is inserted. In the exemplary embodiment shown, the grill grate 3 forms the upper end of the grill 1. The third grill grate 3 rests on a grate retaining flange 5 connected to the side wall 4 that can be seen in FIG. 1. The side wall opposite the side wall 4 that can be seen in the figure likewise carries such a grate retaining flange. A drip pan 7 is placed on the bottom 6 of the housing 2, in which pan cooking liquid dripping from the food on the grate 3 is collected. In this exemplary embodiment, the grate 3 represents the cooking surface of the grill 1.

The cooking surface is divided into two heating zones H₁, H₂. Each heating zone H₁, H₂ can be heated by a first heating element 8, which is located below the grill grate in the part of the grill 1 enclosed by the housing 2. The heating element 8 of the illustrated embodiment is an electrical resistance heating element in the meander or spiral shape typical of such heating elements, as can be seen in the plan view of the heating elements 8 in FIG. 2. In addition to the first heating element 8, a second, similar heating element 9 is arranged below the grate 3 in the heating zone H₁. In the illustrated this element is located at a small distance below the first heating element 8. The heating elements 8, 9 are brought into an intersecting arrangement in their areal extension by straight heating element sections connected to one another by arched sections, as can be seen from the plan view of FIG. 2. The arrangement of the heating elements 8, 9 one above the other in the heating zone H₁ shows that in these heating elements 8, 9 the straight heating coil sections cross one another. This is done against the background that as much heating power as possible from the heating element 9 located at the bottom is not shaded from heat radiation towards the grate 3 by the heating element 8 located above it. In an embodiment not shown in the figures, the two heating elements of the heating zone H₁ are arranged in the same plane. The second heating element of this heating zone is then located in the space between the heating element.

All heating elements 8, 9 have a maximum power input of 1.5 kW. The electric grill 1 is designed for a maximum power input of 3 kW. The electrical power supply of the heating elements 8, 9 is not shown in the figures for the sake of simplicity. In the power supply of the heating elements 8, 9, a heating element changeover switch is switched on, which can be used to select which heating elements 8, 9 are energized and thus which heating zones H₁, H₂ are operated. The heating element switchover feature has an OFF switch position in which none of the heating elements 8, 9 is energized. In the exemplary embodiment shown, the heating element changeover switch has two other switch positions in which either the heating element 8 of the heating zone H₁ or the heating element 8 of the heating zone H₂ is energized. Such an operation of the grill 1 will be chosen when food is to be cooked only in one of the two heating zones H₁, H₂ at low or medium heat. In another position of the heating element changeover switch, the first heating elements 8 of both heating zones H H₂ are energized. Then the cooking surface provided by the grate 3 is heated with uniform heat over its entire surface. In this mode of operation, the maximum permitted 3 kW can be absorbed by the two heating elements 8 if such heating is desired. The heating power of the heating elements 8, 9 can be adjusted in each heating stage.

If the food to be cooked is to be heated to a particularly high degree, the heating zone H₁ is operated with its two heating elements 8, 9. To make this possible, the heating element changeover switch has another switch position in which only the two heating elements 8, 9 of the heating zone H₁ are energized. In this position of the heating element changeover switch, the heating element 8 of the heating zone H₂ is not energized. Thus, the entire possible power input of 3 kW can flow into the heating of the heating zone H₁ in this operating position of the electric grill 1.

The description of the electric grill 1 makes it clear that a maximum energy yield within the permitted maximum power input of the grill is possible in the different operating modes with simple, but very efficient means. The figures show and describe an electric grill 1 with two heating zones by way of example. Such an electric grill can also have more than two heating zones, for example three or four (or even more), while implementing the concept presented.

The electric grill 1 can have a hood that is pivotably hinged to the housing 2. In another embodiment of an electric grill, the hood can be removed from the frame.

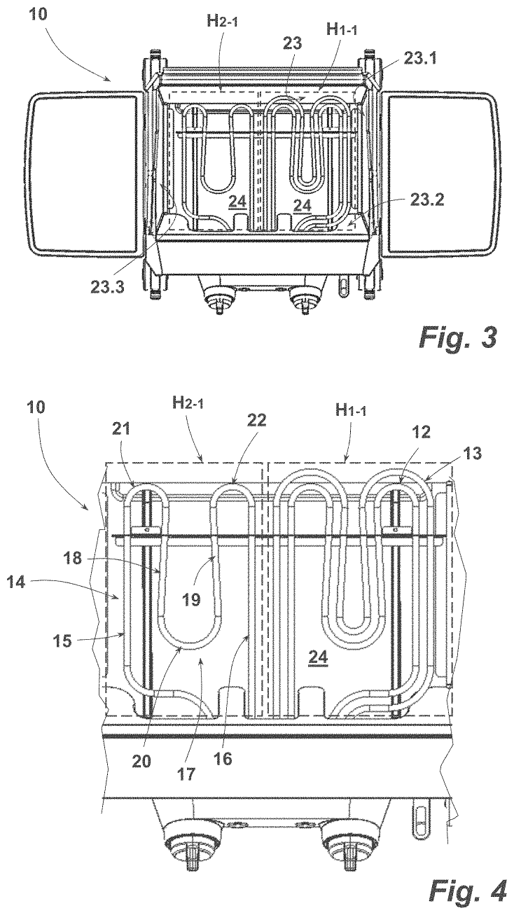

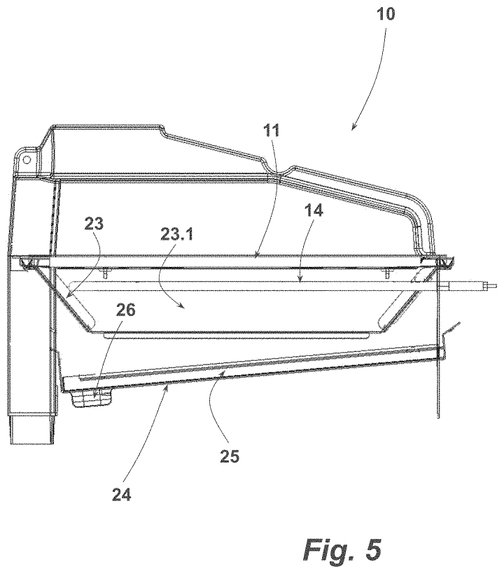

FIG. 3 shows a plan view of another electric grill 10. The grill 10 is shown in the figure without a grate on it. The grate 11 forming the cooking surface in this grill can be seen in the side view of the grill 10 in FIG. 5. The grill 10 also has two heating zones H₁₋₁, H₂₋₁. Two individual heating elements 12, 13 are located in the heating zone H₁₋₁. In the illustrated embodiment, the sections of the heating elements 12, 13 run at a constant distance from one another. To ensure optimum heat dissipation without mutual impairment of the parallel running heating elements 12, 13, the ratio of the pipe diameter to the distance between the heating elements 12, 13 from one another is set at 4:5. The two heating elements 12, 13 are in the same horizontal plane. The heating element 12 forms the inner heating element and the heating element 13 forms the outer heating element. A heating element 14 is arranged in the other heating zone H₂₋₁. In terms of its geometry, this element corresponds to the internal heating element 12 of the heating zone H₁₋₁.

The electric grill with its two heating zones H₁₋₁, H₂₋₁ is operated in the same way as the electric grill 1 described in the exemplary embodiment in FIGS. 1 and 2. The respective statements therefore apply likewise to the operation of the electric grill 10.

The grill 10 differs from the grill 1 in the design of its heating elements 12-14. The heating element 14 is described below with reference to the enlarged illustration of the heating zones H₁₋₁, H₂₋₁ in FIG. 4. The heating elements 12, 13 are constructed in the same way.

The heating element 14 is designed in a helical or meandering manner and has two external heating element legs 15, 16. These are arranged parallel to one another in the exemplary embodiment shown. The free ends of the heating element legs 15, 16 are connected to a power supply not shown in detail. A heating element section 17 is located between the two outer heating element legs 15, 16. The heating element section 17 in turn comprises two heating element legs 18, 19 which are connected to one another by an arched section 20. The heating element legs 18, 19 do not run parallel to one another. The distance between these heating element legs 18, 19 from one another in the transition to the arched section 20 is greater than at their opposite end. At their opposite end, the heating element legs 18, 19 each merge into a connecting arched section 21, 22, which in turn are connected to the outer holding element legs 15, 16 or merge into them. Due to the non-parallel arrangement of the heating element legs 18, 19 of the heating element section 17, the arched section 20 and the two connecting arched sections 21, 22 extend over more than 180°. In the exemplary embodiment shown, the radius of curvature of the curved section 20 is greater than the radius of curvature of the connecting curve sections 21, 22. This arrangement enables better heat distribution and higher heating power to be introduced within the heating zone H₁₋₁ compared to an embodiment in which all the retaining element legs run parallel to one another are arranged, as is the case with the heating elements 8, 9 of the electric grill 1.

The heating elements 12-14 are located within a heating element chamber which is delimited by side panels 23, 23.1, 23.2, 23.3 inclined towards the center of the heating element chamber. The inclination of the side panels 23, 23.2 can be seen in the side view of the grill 10 in FIG. 5. The side panels 23, 23.1-23.3 can be removed from the heating element chamber without tools, for example for cleaning purposes. These are suspended in the heating element chamber.

The heating element chamber is delimited on the underside by a drip plate 24 (see FIG. 5). The drip tray 24 is used to catch cooking liquids, for example liquefied fat or oil, that drip off the grate 11 when a foodstuff is being cooked. As can be seen from FIG. 5, the drip tray 24 is held inclined within the frame of the grill 10. The inclination runs towards the rear of the grill 10. The drip plate 24 has a circumferential edge 25. The drip plate 24 has a collecting channel 26 at its edge area assigned to the deepest end. Cooking liquids collected by the drip plate 24 accumulate therein. As can be seen from FIG. 5, the upper side of the collecting channel 26 is shaded by the side panel 23, as a result of which cooking liquids accumulated in the collecting channel 26 are shielded from direct thermal radiation from the heating elements 12-14. In this way, undesirable inflammation of liquefied fat or oil is effectively prevented.

The description of the drip tray 24 with its inclined arrangement with or without the presence of a collecting channel and its shielding can also be used with other electric grills and is not tied to an electric grill such as, for example, the electric grill 10.

While a number of exemplary aspects and embodiments have been discussed above, those of skill in the art will recognize certain modifications, permutations, additions and sub-combinations therefore. It is therefore intended that the following appended claims hereinafter introduced are interpreted to include all such modifications, permutations, additions and sub-combinations are within their true spirit and scope. Each apparatus embodiment described herein has numerous equivalents.

The terms and expressions which have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. Whenever a range is given in the specification, all intermediate ranges and subranges, as well as all individual values included in the ranges given are intended to be included in the disclosure.

In general the terms and phrases used herein have their art-recognized meaning, which can be found by reference to standard texts, journal references and contexts known to those skilled in the art. The above definitions are provided to clarify their specific use in the context of the invention.

### LIST OF REFERENCE NUMERALS

1 grill
2 housing
3 grill grate
4 side wall
5 grate retaining flange
6 bottom
7 drip pan
8 heating element
9 heating element
10 grill
11 grate
12 heating element
13 heating element
14 heating element
15 heating element leg
16 heating element leg
17 heating element section
18 heating element leg
19 heating element leg
20 arched section
21 connecting arched section
22 connecting arched section
23, 23.1-23.3 side panel
24 drip tray
25 edge
26 collecting channel
H₁, H₁₋₁ heating zone
H₂, H₂₋₁ heating zone

I claim:

1. An electric grill with a cooking surface for cooking food comprising:
the cooking surface having at least two adjacent heating zones;
each heating zone having a first electrical heating element for heating the cooking surface in the corresponding heating zone
at least one second heating element located in a subset of the heating zones for increasing the heating power in this heating zone with a power input that at least matches that of a first heating element of another heating zone and
the grill having a heating element switchover element, such that, when a second heating element is switched on in a heating zone with two heating elements, a power corresponding to the power input of the second heating element that is switched on, or to be switched on, is switched off on a first heating elements in one or more other heating zones or switching on such power to first elements in other heating zones is blocked.

2. The grill of claim 1 wherein in that a maximum power input of each heating element is the same.

3. The grill of claim 1 wherein a mechanical switch is provided for heating element switchover

4. The grill of claim 1 further comprising a control circuit with one or more control sensors for heating element switchover, said control circuit activates relays inserted into the power supply to the heating elements for switching the power supply of the heating elements depending on the control by the control sensors.

5. The grill of claim 1 wherein the cooking surface in a heating zone having both a first and a second heating element has a different surface design than the cooking surface in a heating zone with only one first heating element.

6. The grill of claim 1 wherein the heating elements are electrical resistance heating elements designed as tubular heating elements.

7. The grill of claim 6 wherein the heating elements are arranged in a superposed arrangement such that the second heating element is below the first heating element in a heating zone with a first and a second heating element.

8. The grill of claim 6 wherein the heating elements in a heating zone with a first and a second heating element are designed in the form of a heating coil with straight heating coil sections interconnected by arches and in that the straight heating coil sections of these two heating elements point in different directions.

9. The grill of claim 6, wherein in a heating zone with a first and second heating element, the heating elements are arranged in a common plane.

10. The grill of claim 9, wherein the sections of the two heating elements which are used for heating run at a constant distance from one another.

11. The grill of claim 1 wherein the grill has two heating zones.

12. The grill of claim 1 wherein that the maximum power input of the grill is limited to 3 kW.

13. The grill of claim 1 wherein the sum total of the power input of the first electrical heating elements corresponds to the maximum power of the grill.

14. The grill of claim 1 wherein the cooking surface is a grate and the heating elements are spaced apart from the grate in the vertical direction.

15. The grill of claim 1 further comprising a drip plate arranged below the heating elements, said drip plate inclined within the grill, wherein the drip plate has a collecting channel a deepest end, which collecting channel is preferably shaded by a side panel from direct IR radiation from a heating element.

16. A heating element for an electric grill according of claim 1 wherein:
at least one heating element is a tubular heating element having several heating element legs connected to one another by first curved arched sections;
the heating element section having two outer heating element legs and two non-parallel heating element legs between the two outer heating element legs and a second arched section connecting the non-parallel heating element legs
wherein the distance of the non-parallel heating element legs of the heating element section from one another at the transition into the second arched section connecting them is greater than at the transition between these non-parallel heating element legs and two first connecting arched sections for connecting the non-parallel heating element section to the outer heating element legs.

17. Heating elements according to claim 16, wherein the curvatures of the second curved section connecting the non-parallel heating element legs of the heating element section and the first arched sections connecting the non-parallel heating element legs to the outer heating element legs at their other end extend over more than 180°.

18. The heating element according to claim 17 wherein the radius of the first connecting arched sections differs from the radius of the second arched section connecting the non-parallel heating element legs of the heating element section.

19. The heating element of claim further comprising a second heating element is a tubular heating element having a heating element geometry matching the heating element geometry of the first heating element, and is assigned to said first heating element in the plane of the first heating element for increasing the heating power in this heating zone (H₁₋₁), such that the heating element legs and the arched sections of the two heating elements connecting them run at a constant distance from one another.

20. The heating element according to claim 19, wherein the ratio of the tube diameter of the tubular heating elements of the first and second heating elements to their spacing from one another is between 8:9 and 8:13, in particular approximately 4:5.
